(19) United States
(12) Patent Application Publication
(10) Pub. No.: US 2014/0172725 A1
(43) Pub. Date: Jun. 19, 2014

(54) MAILING LABEL BASED PRODUCT REGISTRATION

(71) Applicant: Chris Gilliam, Dallas, TX (US)

(72) Inventor: Chris Gilliam, Dallas, TX (US)

(21) Appl. No.: 14/069,350

(22) Filed: Oct. 31, 2013

Related U.S. Application Data
(60) Provisional application No. 61/795,942, filed on Oct. 31, 2012.

(51) Int. Cl. G06Q 30/00

(52) U.S. Cl. CPC G06Q 30/012
USPC 705/302

(57) ABSTRACT

The invention disclosed herein provides apparatuses, systems and methods for quickly and easily registering a product, and for storing data in profiles such that advertisements and offers may be delivered in a targeted manner. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CLAIM OF PRIORITY

The invention is related to and claims priority from U.S. Provisional Patent Application No. 61/795,942 filed Oct. 31, 2012 to common inventor Gillium, and entitled Mailing Label Based Product Registration.

### TECHNICAL FIELD OF THE INVENTION

The invention relates generally to product registration.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Consumers are rarely as brand-loyal as they are retailer-loyal. Indeed, as soon as an item is purchased, unless the purchaser actually registers the product with the manufacturer (and less than ⅓ do), the consumer's relationship with the manufacturer ends. As more consumers shop online, the consumer relationship with the manufacturer continues to grow more distant. Accordingly, what manufacturers need are systems, methods and devices that provide the consumer an easy way to register a product, and the present invention provides such. The invention also provides additional benefits for advertisers unrelated to the manufacturers.

### BRIEF DESCRIPTION OF THE DRAWINGS AND TABLE

Various aspects of the invention, as well as an embodiment, are better understood by reference to the following detailed description. To better understand the invention, the detailed description should be read in conjunction with the drawings and tables (if any).

FIG. 1 is an inventive product registration algorithm.

FIG. 2 illustrates an alternative product registration algorithm.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “attaching” may be done by hook-and-loop attachment (such as Velcro®), snaps, hooks, belts, etc., and so a use of the word attaching invokes all methods of attachment known in and anticipated by the art, and all other modes of that word and similar words).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

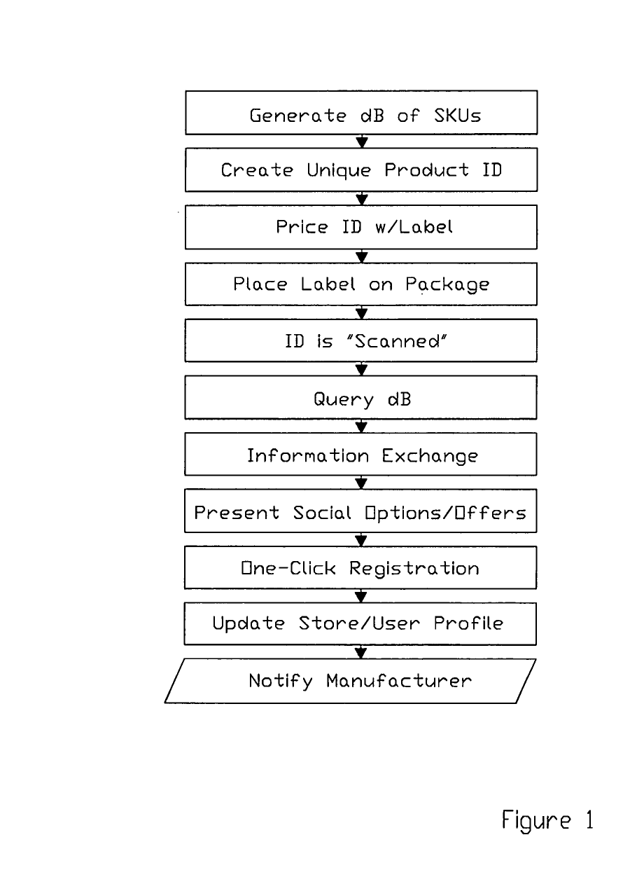

The invention is in one aspect a product registration algorithm (“the algorithm”) as illustrated in FIG. 1. The algorithm begins when a database of SKUs (Stock Keeping Units) is generated. Then, a unique product identifier (ID) is created for each SKU. Next, in a Print ID with Label act, at least one label is created and printed with the unique product ID thereon. Following the creation of the label, the label is placed on a package. Eventually, the package is delivered and the ID is scanned (either by the consumer or by the service delivering the package). At this point, the database is queried, and the product delivered is associated with the consumer who receives the package, or with another person (either at the time of scanning or at a later date), which takes place in an information exchange act.

Following the information exchange, the recipient may “share” or otherwise socialize the purchase or receipt of the item, and the manufacturer or other entity in the supply chain may make an offer to the recipient. Next, the recipient may choose to register the purchase (or item(s)) as their own, including in a “one-click” manner. Following registration of an item by a user, a user profile is updated in a user profile database, and the manufacturer is notified that the registrant has acquired the item in a notify manufacturer act.

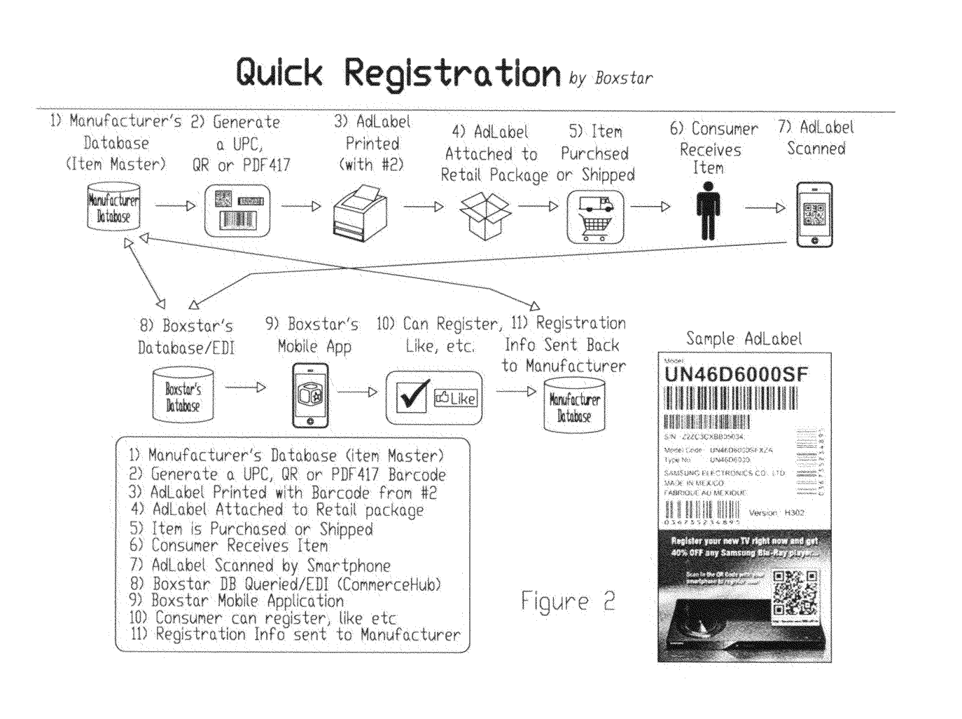

FIG. 2 illustrates an alternative product registration algorithm (a first alternative algorithm). In the first alternative algorithm, a sample label having a desired product identification (ID) thereon is show. The sample label also includes an exemplary offering that may be associated with a product registration. The first alternative algorithm also illustrates a variety of order possibilities associated with a purchase registration algorithm.

Another way of looking at the registration process is as a step-wise collection of acts, in which:
1. At a manufacturer's database, a Master Item List from the manufacturer is queried for a relevant SKU.
2. Next, a UPC, QR, or PDF417 is generated. In this process, a 2-dimensional barcode is generated for the item in a UPC, QR Code, or PDF417 format.
3. Then, in a QuickRegistration label printed step, a pre-printed full-color label is sent through the printer where the barcode is printed directly onto the label in the whitespace provided.
4. An AdLabel is applied to the outside of an appropriate retail package, and may or may not contain a special offer.
5. Whether in-store or via delivery, the item is purchased.
6. Next, the consumer receives the item(s) either in the store (such as BestBuy®, for example) or via delivery (such as UPS®, FedEx®, or USPS®, for example)
7. Then, the label is scanned, such as with a smartphone. In one embodiment, the Barcode is scanned from a smartphone using a Barcode reading app such as RedLaser® or ShopSavvy®, for example.
8. In a local (non-manufacturer) database, a unique identifier (from the barcode) is sent to a server where it is used to query the local database and present a dynamic Web App back to the smartphone (or other smart device, such as a tablet) with preferably an image and basic information about the item, with options.
9. Next, in a web application for registering (and for social interaction, such as “liking”), the web application (hosted on the local server) presents the consumer with options to register their Item, Like it on a social network such as Facebook®, for example.
10. Then, registration of item takes place, whereby the consumer can register the item using one-click log-in (such as through Facebook®).
11. To complete the algorithm, the registration information is delivered back to the manufacturer. Here, the registration information is preferably sent back to the manufacturer utilizing an integration service (such as CommerceHub®, for example), and in a recognizable format such as ANSI x.12 or Item Master 888.

Although the invention has been described with respect to a specific preferred embodiment, many variations and modifications, including equivalents, will become apparent to those skilled in the art upon reading the present application. It is therefore the intention that the appended claims and their equivalents be interpreted as broadly as possible in view of the prior art to include all such variations and modifications.

I claim:

1. A method that converts a general computing machine into a specific computing device, comprising:
at a first manufacturer database, associating an item with a label;
receiving a notification that the item has been received at a second database;
receiving verification that the item is associated with a consumer via a consumer acknowledgement; and
delivering registration information to the first manufacturer database.
